(19) United States
(12) Patent Application Publication
(10) Pub. No.: US 2012/0209725 A1
(43) Pub. Date: Aug. 16, 2012

(54) METHODS AND SYSTEMS FOR PROVIDING ADVERTISING AND PREVENTING ADVERTISING FRAUD

(76) Inventor: Keith David Bellinger, Beverly Hills, CA (US)

(21) Appl. No.: 13/028,198

(22) Filed: Feb. 15, 2011

(51) Int. Cl. G06Q 30/00

(52) U.S. Cl. 705/14.73

(57) ABSTRACT

In one embodiment, a method of displaying advertising is provided. The method comprises determining the y-axis of a page to be displayed on the internet, determining the relative y-axis position of at least some portion of one or more advertisements on the page to be displayed on the internet, determining the y-axis position of the portion of the page that is currently displayed to or viewed by the user and causing the one or more advertisements on the page to download or display when the y-axis position of the portion of the page that is currently displayed to or viewed by the user is equal to or greater than the relative y-axis position of at least some portion of the one or more advertisements on the page to be displayed on the internet, all of which is accomplished on a computer.

### REFERENCE TO APPENDIX

The source code for the present disclosure is located in an appendix at the end of the present disclosure, and is incorporated herein by reference. A portion of the disclosure of the present disclosure contains material that is subject to copyright protection. The copyright owner of that material has no objection to the reproduction by anyone of the patent document or the patent disclosure, as in appears in the Patent and Trademark Office patent files or records, but otherwise reserves all copyright rights.

### BACKGROUND

1. Technical Field

The present disclosure relates generally to providing advertisements (ads) over a large network and preventing advertising fraud, and particularly for methods and systems for providing advertising over the Internet and preventing advertising fraud.

2. Description of Related Art

Consumers have grown accustomed to internet advertising, whether it is in the form of pop-up ads, banner ads, or ads on search engine results pages, to name a few. Some ads are constantly looping, while some play through once, others are static with no animation, others play a video as the page loads, and other full-page takeovers cover the entire screen. Ads may be constructed from an image, JavaScript program, or multimedia object using technologies like Java, Shockwave, or Flash, which often use animation, sound, or video to attract the user's attention. Loading multiple ads with multimedia elements takes considerable time, especially on a slow Internet connection, and frustrates the user. A user may not pay attention to the ad in their haste to get to the webpage they wanted to originally visit, and be annoyed that their webpage took so long to load.

Further, if all of the ads load at once on the user's page, some ads may have lost their attention-grabbing ability by the time the user has scrolled to the location of the ad. One advertising technique of such ads might be that the ad has a graphic animation that is initially exciting, to attract the user's attention, but then the ad completes animating and settles down to a constant, unchanging graphic, with more detailed information on the product or service in the advertisement. Another example of an effective ad is a video ad that plays a short video advertising the product or service. If the ad is outside of the view of the user when the world wide web page first loads (often referred to as the ad being below the fold), the user does not view the ad unless he scrolls down to that portion of the webpage. By the time the user reaches the ad on the lower part of the webpage, the user may have missed the exciting part of the animating ad, or see the video midway through or miss it entirely. As a result, the user's experience with the advertisement is negatively affected and the ad effectiveness is diminished or eliminated.

There are also concerns for the advertiser. There are various ways online advertisers are charged for their ads. One example is called Cost Per View (CPV), where the advertiser pays for each unique user view of an ad or website. Another example is Cost Per Mille (CPM), where advertisers pay for exposure of their message to a specific audience. Per mille means per thousand impressions, or loads of an ad. However, some impressions may not be counted, such as a reload or a user not reaching the ad. With such payment methods, advertisers are often paying for an ad that the user never sees. As a result, advertisers are presently paying for advertising that is never seen by any user, because they are below the fold, or because at least some of the ad is not displayed to the user, but because it auto-animates when the page load it is still counted as an impression. In some instances this results in advertising fraud because the advertiser pays for impressions/ads that were never viewed by any user.

Lastly, there are concerns on the server's end. Even though an ad is not within view, the server needs to serve the ad for the webpage to load. It is believed that approximately 44% of all ads are below the initial viewable area of a webpage (i.e., below the fold). If such ads were loaded when the ads were in view, it would save time, in loading a page, bandwidth, processing power and allow the ad to play when the user is more engaged with the webpage. Allowing ads to load when they are in view would prove beneficial to the user, by improving the user's experience, the advertiser, and the server.

### SUMMARY

One aspect of the present disclosure is to provide an improved browsing experience for the advertiser and user, in which the user is able to view a target webpage quicker, since ads that are not in view do not load until the ad is within view, and the advertiser is able to display his message when the webpage has finished loading.

Another aspect of the present disclosure is to provide increased efficiency for the server on which the ad is located. If the ad is not within view, the server does not need to serve the ad.

Another aspect of the present disclosure is to prevent advertising fraud, in that ads that are not visible will not count as impressions that the advertiser pays for.

In at least one embodiment of the present disclosure, a method is provided wherein when the web page loads, the ad scripting language file (e.g, SmartAds.js), is loaded. In one embodiment, having instantiated a SmartAds class instance, one or more ads can be added using the class's add method. As part of that method, banners are specified with this method using their HyperText Markup Language (HTML) attribute. The SmartAds class uses a timer to constantly check the vertical y-axis positions of all ad banners, and compares each one to the current scroll position of the web browser. If the users current viewable browser area has no visible banners the SmartAds class remains inactive and the ads that are below the fold do not load or animate. When the users scroll position is greater than the ad banner position, which means an ad would now be visible in the users current browser, the SmartAds class calls the banner's activate method, which should contain any initialization and animation code thus triggering the ad to animate.

In yet another embodiment of the present disclosure, a method is provided wherein the website that is displaying ads using this SmartAds method would not have to make any changes to allow this method to work. The ad serving network would implement the SmartAds class within their ad serving technology that would monitor the position of the ad relative to scroll position of the web browser. As a result this method could easily be implemented across entire ad networks with no changes needed on individual websites.

In yet another embodiment of the present disclosure, a method is provided wherein the website that is displaying ads using this SmartAds method would not have to make any changes to allow this method to work. The ad serving network would implement the SmartAds class within their ad serving technology that would monitor the position of the ad relative to scroll position of the web browser. As a result this method could easily be implemented across entire ad networks with no changes needed on individual websites.

In yet another embodiment of the present disclosure, a method is provided wherein the website or a third party program running on a computer monitors the position of the ad relative to scroll position of the web or internet browser and once at least a portion of the advertisement can be viewed by the viewer of the browser or is close to being viewed by the viewer of the browser, the website or third party program running on the program causes the advertisement to load, be viewed and/or run. It should be appreciated that the method of monitoring the position of the add relative to the scroll position of the web or internet browser can be accomplished in a variety of ways which are well known in the art.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it is intended to refer to the same or like components or steps.

FIG. 1 is a screenshot of the top of the webpage in accordance with at least one embodiment of the present disclosure.

FIG. 2 is a screenshot of the middle of the webpage in accordance with at least one embodiment of the present disclosure.

FIG. 3 is a screenshot of the bottom of the webpage in accordance with at least one embodiment of the present disclosure.

FIG. 4 is a flowchart of the steps that occur during at least one embodiment of the present disclosure.

### DETAILED DESCRIPTION OF ILLUSTRATIVE EMBODIMENTS

Illustrative embodiments are now discussed. Other embodiments may be used in addition or instead. Details that may be apparent or unnecessary may be omitted to save space or for a more effective presentation. Conversely, some embodiments may be practiced without all of the details that are disclosed.

While the following disclosure and drawings disclose a banner ad method of Internet advertising, this disclosure is not limited to banner ads or Internet advertising. The present disclosure also extends to other methods of online advertising including, but not limited to, banner ads, Rich Media ads, social network advertising, video ads, advertising networks and e-mail marketing, iAds, mobile ads, iPad ads, advertising on digital media receivers (Apple TV, Google TV, Roku). The present disclosure also extends to any digital content viewing medium that requires use of a scrollbar, such as, but not limited to, the Internet, interactive televisions, and cell phones.

The add( )method is very straightforward. It tells the SmartAds class to add a Flash banner to its list of Flash objects it is tracking. More specifically, the parameter that you pass in to the add( )method is the HTML DOM id of the Flash object you want to track. This method should generally be called after the SmartAds class is created in the ad network JS code, and should be called for each Flash ad on the HTML page that you wish to track.

The activate( )method is internal to the SmartAds class; it is called by the class when it detects that one of the Flash objects it is tracking has become visible in the browser window. When it is called, it finds the Flash object that was passed in the method parameter and calls an activation method within the Flash object. This activation method is not inherit to Flash itself; it must be put in by a Flash developer using Actionscript code. How the unit activates via this method is up to the Flash developer.

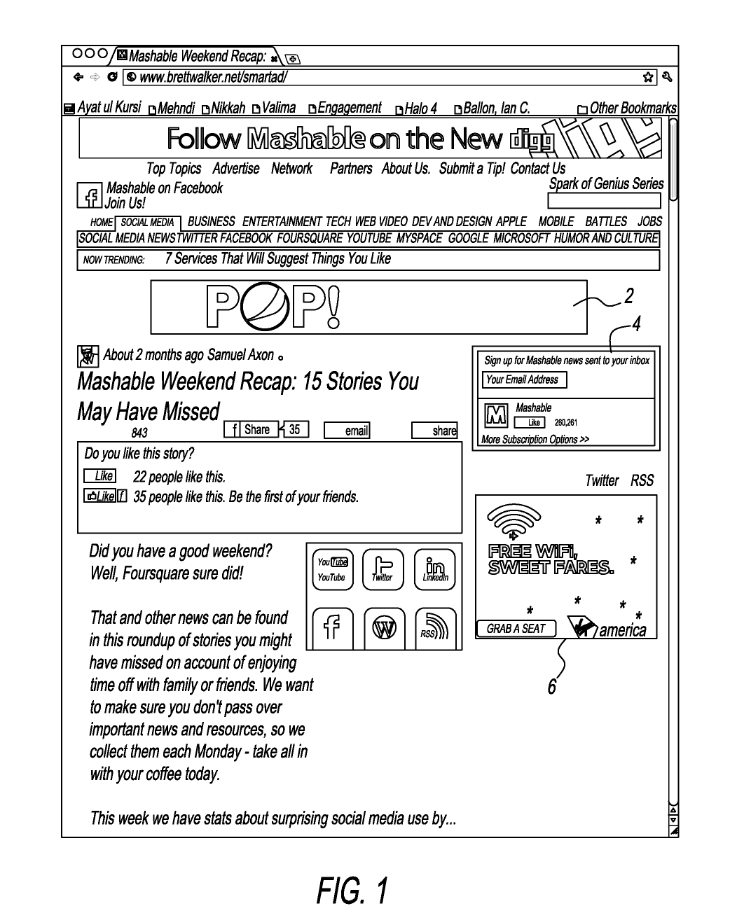

FIG. 1 is a screenshot of the top portion of the webpage. At this point, the webpage is fully loaded, and the top banner ad is beginning to load. In the illustrated example, a Pepsi ad 2 is shown, which diverts the user's attention by a series of moving words, specifically, “Pop! Pop! Boom!” before the end of the ad 2, in which Pepsi is shown with its benefits and features. The top ad 2 plays instantly, as it is above the fold and within the initial viewing area. The ads that are further down the page, in this case two ads 4 and 6, play once the user scrolls down so that they are viewable. In one aspect of at least one embodiment, the ad is downloaded and/or displayed when at least a specified portion of the ad is visible. In another aspect of at least one embodiment, the ad is downloaded and/or displayed when most to all of the ad is visible to the user.

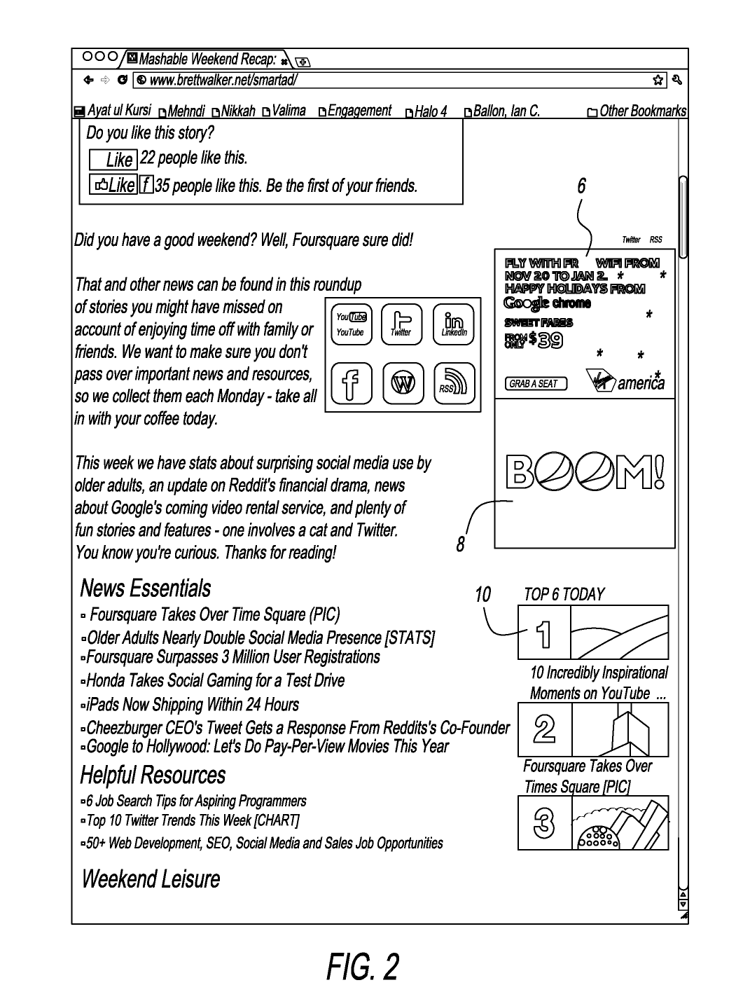

FIG. 2 is a screenshot of the middle of the webpage. In the present figure, various aspects of at least one embodiment are demonstrated. More specifically, the scrollbar has been lowered, activating the second ad 8 in the middle of the page. The third ad 10 is also visible in the figure. However, since the scroll position is not greater than the ad banner position, the ad has not yet activated.

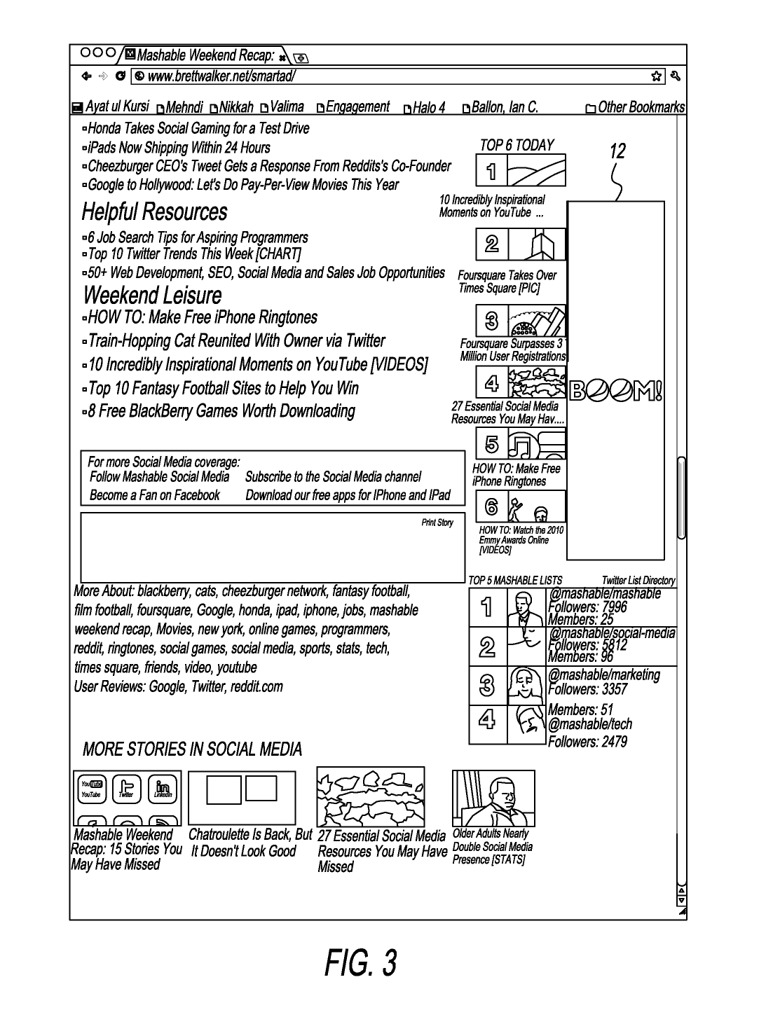

FIG. 3 is a screenshot of the bottom of the webpage. In the present figure, various aspects of at least one embodiment are demonstrated. More specifically, the figure demonstrates the scroll position being in a position that is greater than the ad banner position, so the banner ad 12 is activated/downloaded and/or displayed. It should be appreciated that the initialization and animation code can be located in the banner add or in another location. In at least one embodiment, the ad plays and activates only when the user has scrolled down to cause a specified portion of the ad visible.

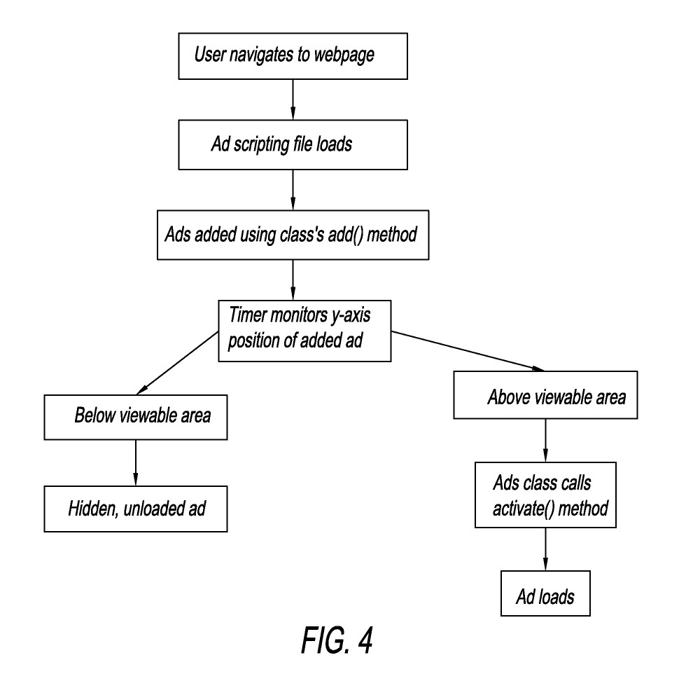

FIG. 4 is a flowchart of the steps that occur during an embodiment of one method of the present disclosure. Once a user navigates to the webpage where one or more ads are located, an ad script language file (e.g., SmartAds.js) is loaded. Ads that are located on the webpage are usually served from a media server. Some ads are hard-coded directly by the websites themselves but this is rare. Once on the page, the timer will continually measure the y-axis position of all added banners, and compare each position to the current scroll position of the web browser. If the scroll position is greater than the ad banner position, the banner's activate method (which should contain any initialization and animation code) is initiated and the ad is downloaded/displayed and/or played. If the scroll position of the web browser is less than the ad banner position, the ad will not download/display or play, and the ad will remain inactivate.

In one embodiment of the present disclosure, the methods of the present disclosure can be implemented by creating or partnering with an existing digital ad serving network. When a digital advertisement is typically served on a webpage, it is often served through an ad serving network. In one aspect of one or more embodiments, a flash banner advertisement is served up by the ad serving network. In another aspect of one or more embodiments, the flash files (e.g., .fla and .swf) are delivered to the ad ops team at the ad serving company.

In at least one embodiment of the present disclosure, two actions need to be taken to serve an ad as a smart ad. First the ad ops team serving the ad would need to open up the .fla file and add an Actionscript code that instructs the ad to receive the activation command from the javascript file (smartads.js). Secondly the smartads.js file would need to be hosted on the ad serving network, and linked to by the ad network's Javascript ad serving code. Once linked, the SmartAds code can be instantiated as an object, and it can be told which ads to track by passing each ad's HTML id into the SmartAds' add( ) method. Once the actionscript code has been added to the .fla file, the ad ops team would republish the file, outputting a .swf file. This .swf file would now be ready to traffic out to all sites included within the media buy, and would now include the ability to be served as a smart ad, or more specifically as the ad becomes viewable upon the webpage and not upon page load.

In yet another aspect of at least one embodiment of the present disclosure, the only software that would be needed would be Adobe Flash to add the Actionscript code to the .fla, and republish as a .swf and the only hardware needed would be the servers needed to serve the ads.

Nothing that has been stated or illustrated is intended or should be interpreted to cause a dedication of any component, step, feature, object, benefit, advantage, or equivalent to the public, regardless of whether it is recited in the claims.

Nothing that has been stated or illustrated is intended or should be interpreted to cause a dedication of any component, step, feature, object, benefit, advantage, or equivalent to the public, regardless of whether it is recited in the claims.

It should be appreciate that the scope of the present invention also include the method of causing the advertisement to be viewed, load and/or run when the advertisement comes into close proximity to area where it would be viewed by the user.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

It should be appreciated that for the purpose of the present disclosure a computer is a programmable machine that receives input, stores and manipulates data, and provides output in a useful format, which includes but is not limited to a laptop, phone, PDA, desktop or other device having a processor, memory and input mechanism.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The phrase “means for” when used in a claim is intended to and should be interpreted to embrace the corresponding structures and materials that have been described and their equivalents. Similarly, the phrase “step for” when used in a claim embraces the corresponding acts that have been described and their equivalents. The absence of these phrases means that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

### APPENDIX

smartbanner.js—This file contains the SmartAds class, which tracks Flash files specified by the user and notifies the Flash files when they become visible within the browser window.

Reference code for smartbanner.js
/**

| | |
|---|---|
| * | SmartAds allow the playback of banner animations to occur |

when the user is viewing them, not upfront.
*

| | |
|---|---|
| * | @author Brett Walker (brett at brettwalker dot net) |
| * | @version 1.000 |

*/
var punkinmyoven = punkinmyoven || { };
punkinmyoven.ads = punkinmyoven.ads || { };
punkinmyoven.ads.SmartAds = new punkinmyoven.Class({

constructor: function ( ) {

var self = this;
this.ads = new punkinmyoven.utils.Dictionary( );
this.interval = window.setInterval(function ( ) {

self.timerUpdate.apply(self) }, 100);

},
/**
* Adds a Flash object to be tracked
*
* @param adID The id property of the Flash DOM object to
be tracked
*
*/
add: function (adID) {

this.ads.set(adID, false);

},
activate: function (adID) {

// tells a specified ad to activate
var ad = this.ads.get(adID);
this.ads.set(adID, true);
// tell the flash
var ad_ref = this.getAdRef(adID);
//debug(adID + “ ” + ad_ref)
ad_ref.activate( );

},
isActivated: function (adID) {

return this.ads.get(adID);

},
timerUpdate: function ( ) {

this.checkAds( );

},
checkAds: function ( ) {

// check all ads in the ads Dictionary object for visibility
var scroll_y = this.getScrollOffset( );
var len = this.ads.keys.length;
for (var i=0; i < len; i++) {

var ad_name = this.ads.keys[i];
if (!this.isActivated(ad_name)) {

var ad = this.getAdRef(ad_name);
if (ad) {

var ad_pos = this.getPos(ad).y;
if (ad_pos == 0) {

ad_pos = this.getPos(ad.parentNode).y +

ad.parentNode.scrollHeight;

}
var scroll_pos = this.getWindowHeight( ) +

scroll_y;

if (scroll_pos >= ad_pos + ad.scrollHeight) {

// we found a visible ad, so tell it to activate
this.activate(ad_name);

}

}

}

};

},
getAdRef: function (adName) {

// try to get a DOM reference to the specified ad
var ref = window.document[adName];
if (ref) { return ref; }
// that didn't work so try this
return document.getElementById(ad_name);

},
getScrollOffset: function ( ) {
var h = window.pageYOffset ||

```
  document.body.scrollTop ||
  document.documentElement.scrollTop;
```

return h ? h : 0;
},
getWindowHeight: function ( ) {

return “innerHeight” in window

```
  ? window.innerHeight
  : document.documentElement.offsetHeight;
```

},
getPos: function (obj) {

var curleft = curtop = 0;
if (obj.offsetParent) {

curleft = obj.offsetLeft;
curtop = obj.offsetTop;
while (obj = obj.offsetParent) {

curleft += obj.offsetLeft;
curtop += obj.offsetTop;

}

}
return {“x”:curleft, “y”:curtop};

},

```
});
smartad.fla -- This is an example Flash file, containing Actionscript code
to respond to notifications from the SmartAds Javascript class.
*** Relevant portion of the FLA file's Actionscript code:
=============================================
import flash.system.Security;
import flash.external.ExternalInterface;
// SmartAds demonstration
// author: Brett Walker (brett at brettwalker dot net)
flash.system.Security.allowDomain(“*”);
ExternalInterface.addCallback(“activate”, activate);
function activate( ):void {
  // we've received notification from Javascript, so start ad animation
  gotoAndStop(“activate”);
}
=============================================
Additional foundation files for smartbanners.js:
class.js -- This code creates a pseudo object-oriented structure in
Javascript, which code can inherit from to behave in a class-like,
object-oriented way.
dictionary.js -- The Dictionary class emulates an Actionscript 3-style
Dictionary object.
```

What is claimed is:

1. A method of displaying advertising on a computer, the method comprising:
determining the y-axis of a page to be displayed on the internet on a computer;
determining the relative y-axis position of at least some portion of one or more advertisements on the page to be displayed on the internet on a computer;
determining the y-axis position of the portion of the page that is currently displayed to or viewed by the user on a computer; and
sending a signal or otherwise causing the one or more advertisements on the page to download on a computer or display when the y-axis position of the portion of the page that is currently displayed to or viewed by the user is equal to or greater than the relative y-axis position of at least some portion of the one or more advertisements on the page to be displayed on the internet.

2. The method of advertising of claim 1, wherein determining the y-axis position of the portion of the page that is currently displayed to or viewed by the user is determined by identifying the current scroll position of the user viewing the page displayed on the internet on a computer.

3. The method of advertising of claim 1, wherein determining the y-axis position of the portion of the page that is currently displayed to or viewed by the user is determined by determining what portion of the page the user is currently viewing on a computer.

4. The advertising method of claim 1, wherein sending a signal or otherwise causing the one or more advertisements on the page to download or display when the y-axis position of the portion of the page that is currently displayed to or viewed by the user is equal to or greater than the relative y-axis position of at least some portion of the one or more advertisements on the page to be displayed includes activating the initialization and animation code on a computer.

5. The advertising method of claim 1, wherein the digital content viewing system is any digital system where scrollbars are necessary and graphical ads are initially off-screen.

6. The advertising method of claim 1, wherein the digital content viewing system is an Internet web browser.

7. The advertising method of claim 1, wherein the digital content viewing system is an interactive television.

8. The advertising method of claim 1, wherein the digital content viewing system is a mobile phone, or a mobile phone application.

9. The advertising method of claim 1, wherein a server does not need to serve an advertisement if the advertisement is not within view.

10. The advertising method of claim 1, wherein delayed loading of an advertisement allows for faster loading of the digital content viewing system page.

11. The advertising method of claim 1, wherein advertisements that are not visible will not count as impressions that the advertiser pays for.

12. The advertising method of claim 1, wherein an advertisement is a banner advertisement.

13. The advertising method of claim 1, wherein an advertisement is a Rich Media advertisement.

14. The advertising method of claim 1, wherein an advertisement is on a social networking website.

15. The advertising method of claim 1, wherein an advertisement is a video advertisement.

16. The advertising method of claim 1, wherein an advertisement is on an advertising network.

17. The advertising method of claim 1, wherein an advertisement is embedded in e-mail marketing.

18. A method of displaying advertising on a computer, the method comprising:
determining the y-axis of a page to be displayed on the internet on a computer;
determining the relative y-axis position of at least some portion of one or more advertisements on the page to be displayed on the internet on a computer;
determining the y-axis position of the portion of the page that is currently displayed to or viewed by the user on a computer; and
sending a signal or otherwise causing the one or more advertisements on the page to download or display on a computer when the y-axis position of the portion of the page that is currently displayed to or viewed by the user is in close proximity to the relative y-axis position of the one or more advertisements on the page to be displayed on the internet.

19. The method of advertising of claim 18, wherein determining the y-axis position of the portion of the page that is currently displayed to or viewed on a computer by the user is determined by identifying the current scroll position of the user viewing the page displayed on the internet.

20. The method of advertising of claim 18, wherein determining the y-axis position of the portion of the page that is currently displayed to or viewed on a computer by the user is determined by determining what portion of the page the user is currently viewing.
